(19) United States
(12) Patent Application Publication
(10) Pub. No.: US 2005/0141614 A1
(43) Pub. Date: Jun. 30, 2005

(54) Motion estimation unit and method of estimating a motion vector

(76) Inventors: Ralph Antonius Cornelius Braspenning, Eindhoven (NL); Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/510,301

(22) PCT Filed: Mar. 20, 2003
(86) PCT No.: PCT/IB03/01090

(30) Foreign Application Priority Data
Apr. 11, 2002 (EP) 02076439.5

(51) Int. Cl. H04N 7/12

(52) U.S. Cl. 375/240.16; 375/240.24; 375/240.12

(57) ABSTRACT

A motion estimation unit for estimating a motion vector for a group of pixels of an image of a series of images, comprises: generating means for generating a set of motion vector candidates for the group of pixels; matching means for calculating match errors for the respective motion vector candidates of the set; selecting means for selecting a first one of the motion vector candidates as the motion vector for the group of pixels, on basis of the match errors; and testing means for testing whether the group of pixels has to be split into sub-groups of pixels for which respective further motion vectors have to be estimated, similar to the motion vector being estimated for the group of pixels, the testing based on a measure related to a particular motion vector.

The invention relates to a motion estimation unit for estimating a motion vector for a group of pixels of an image of a series of images.

The invention further relates to an image processing apparatus comprising:
receiving means for receiving a signal representing a series of images to be processed;
a motion estimation unit for estimating a motion vector for a group of pixels of an image of the series of images; and
a motion compensated image processing unit for processing the series of images, which is controlled by the motion estimation unit.

The invention further relates to a method of estimating a motion vector for a group of pixels of an image of a series of images.

2-D motion estimation solves the problem of finding a vector field \vec{d}(\vec{x},n), given two successive images f(\vec{x},n−1) and f(\vec{x},n) where \vec{x} is the 2-D position in the image and n is the image number, such that
f(\vec{x},n−1)=f(\vec{x}+\vec{d}({right arrow over (x+EE,n),n) (1) )}

2-D motion estimation suffers from the following problems:
Existence of a solution: No correspondence can be established for portions in an image which are located in a so-called uncovering areas. This is known as the “occlusion problem”.
Uniqueness of the solution: The motion can only be determined orthogonal to a spatial image gradient. This is known as the “aperture problem”.
Continuity of the solution: Motion estimation is highly sensitive to the presence of noise in the images.

Because of the ill-posed nature of motion estimation, assumptions are required about the structure of the 2-D motion vector field. A popular approach is to assume that the motion vector is constant for a block of pixels: model of constant motion in blocks. This approach is quite successful and used in for instance MPEG encoding and scan-rate up-conversion. Typically, the dimensions of the blocks are constant for a given application, e.g. for MPEG-2 the block size is 16×16 and for scan-rate up-conversion it is 8×8. This introduces the constraint that
\vec{d}(\vec{x},n)=\vec{d}(\vec{x}′,n), ∀\vec{x}′εB(\vec{x}) (2)
where B({right arrow over (x))} is the block of pixels at position \vec{x}=(x₀,x₁) i.e.
B(\vec{x})={\vec{x}′|x′divβᵢ=xᵢdivβᵢ, i==0,1} (3)
and β₁ are the block dimensions.

The choice for a predetermined block size is a trade-off between spatial accuracy and robustness. For larger block sizes, motion estimation is less sensitive to noise, and the “aperture” is bigger, therefore, reducing the “aperture problem”. Hence, larger block sizes reduce the effect of two out of three problems. However, bigger block sizes reduce the spatial accuracy, i.e. one motion vector is assigned to all pixels of the block. Because of the trade-off between spatial accuracy and robustness it has been proposed to use variable block sizes. An embodiment of the motion estimation unit of the kind described in the opening paragraph is known from U.S. Pat. No. 5,477,272. In that patent a top-down motion estimation method is described, i.e. starting with the largest blocks. The motion vectors are first computed for the highest layer, which serves as an initial estimate for the next layer, and so on. Motion vectors are calculated for all blocks including those with the smallest possible block sizes. Hence the method is relatively expensive from a computing point of view.

It is an object of the invention to provide a motion estimation unit of the kind described in the opening paragraph which provides a motion vector field for variable sizes of groups of pixels of an image and which has a relatively low computing resource usage.

The object of the invention is achieved in that the motion estimation unit for estimating a motion vector for a group of pixels of an image of a series of images, comprises:
generating means for generating a set of motion vector candidates for the group of pixels;
matching means for calculating match errors for the respective motion vector candidates of the set;
selecting means for selecting a first one of the motion vector candidates as the motion vector for the group of pixels, on basis of the match errors; and
testing means for testing whether the group of pixels has to be split into sub-groups of pixels for which respective further motion vectors have to be estimated, similar to estimating the motion vector for the group of pixels, the testing being based on a measure related to a particular motion vector of the series of images.

The motion estimation unit is designed to estimate motion vectors initially with relatively large groups of pixels, e.g. 32×32 pixels. After a motion vector has been estimated for the group, it is verified whether the motion vector is representative for the whole group of pixels. If this is not the case then the group of pixels is split into sub-groups. After splitting, motion vectors are also estimated for the sub-groups by applying the generating means, the matching means and the selecting means. If the test results in a positive result, i.e. the particular motion vector is appropriate, then the group of pixels is not split and the estimated motion vector is assigned to the pixels of the group of pixels. In this case no further motion estimation steps are required and hence no additional computer resource usage is needed.

In an embodiment of the motion estimation unit according to the invention the particular motion vector is the first one of the motion vector candidates. Preferably the measure which is used for the test is related to the motion vector candidate which is selected as the best matching motion vector.

In an embodiment of the motion estimation unit according to the invention the group of pixels corresponds to a block of pixels and the sub-groups of pixels corresponds to respective sub-blocks of pixels. The groups of pixels might form an arbitrary shaped portion of the image, but preferably the group of pixels corresponds to a block of pixels. This is advantageous for the design of the motion estimation unit.

In an embodiment of the motion estimation unit according to the invention, the testing means are designed to test whether a first one of the sub-block of pixels has to be split into further sub-blocks of pixels for which respective other motion vectors have to be estimated, similar to the motion vector being estimated for the block of pixels. Splitting the images into blocks and the blocks into sub-blocks, etcetera is repeated recursively. For the various blocks and sub-blocks, motion vectors are calculated.

In an embodiment of the motion estimation unit according to the invention the matching means are arranged to calculate the match error of the motion vector which corresponds to a sum of absolute differences between values of pixels of the block of pixels and respective further values of pixels of a further block of pixels of another image of the series of images. This match error is relatively robust and can be calculated with relatively few computer resource usage. It is common practice, to evaluate the validity of a candidate motion vector, \vec{c}, by calculating a match error ε. A popular criterion is the SAD, i.e.

$$ɛ ( \vec{c} , \vec{x} , n ) = {\sum }_{{{x}^{->}}^{′} ∈ B ( \vec{x} )} \vert f ( {\vec{x}}^{′} , n ) - f ( {\vec{x}}^{′} + \vec{c} , n - 1 ) \vert \qquad ( 4 )$$

This match error ε is minimized varying \vec{c} in order to obtain the best matching motion vector for the block \vec{d}(\vec{x},n), i.e.

$$\vec{d} ( \vec{x} , n ) = arg {min}_{{c}^{->}} ( ɛ ( \vec{c} , \vec{x} , n ) ) \qquad ( 5 )$$

As can been seen in Equation 4, the match error calculations require the computation of a number of differences of values of pixels shifted over the motion vector. If the block dimensions are doubled in both directions, the number of differences of values of pixels increases with a factor four. However, the number of blocks decreases with a factor of four, so the number of calculations per image remains the same. Optionally sub-sampling is applied for the calculation of the match errors, i.e. only a portion of the pixels of a block are applied.

In an embodiment of the motion estimation unit according to the invention the measure related to the particular motion vector is based on a difference between the motion vector and a neighbor motion vector being estimated for a neighbor block of pixels in the neighborhood of the block of pixels. In this embodiment the splitting is based on the vector field inconsistency VI. That means that if the motion vectors locally differ more than a predetermined threshold then it is assumed that these motion vectors do not belong to one and the same object in the scene being captured, i.e. represented by the series of images. In that case the block should be split in order to find the edge of the object. At the other hand, the block does not have to be split any further if the neighboring blocks of pixels have the same, or hardly distinct motion vectors. In that case it is assumed that the blocks correspond to the same object.

In an embodiment of the motion estimation unit according to the invention the measure related to the particular motion vector is based on a difference between a first intermediate result of calculating the match error and a second intermediate result of calculating the match error, the first intermediate result corresponding to a first portion of the block of pixels and the second intermediate result corresponding to a second portion of the block of pixels. These intermediate results are also used as match errors for sub-blocks. Hence, computer resource usage is minimized.

In an embodiment of the motion estimation unit according to the invention the testing means are designed to test whether the block of pixels has to be split into the sub-groups of pixels, on basis of a dimension of the block of pixels. Another criterion to test whether the block should be split is the dimension of the block. This additional criterion enables flexibility in resource usage: if relatively much computing resources usage is allowed the splitting might be continued till fine grain blocks and if relatively little computing resources usage is allowed the splitting might be continued till coarse grain blocks. It should be noted that by adapting the threshold of the other criterion, i.e. measure, the granularity of blocks can be controlled too.

An embodiment of the motion estimation unit according to the invention comprises a merging unit for merging a set of sub-blocks of pixels into a merged block of pixels and for assigning a new motion vector to the merged block of pixels, by selecting a first one of the further motion vectors corresponding to the sub-blocks of the set of sub-blocks. Neighboring blocks are merged if they have motion vectors which are mutually equal or if the difference between their motion vectors is below a predetermined threshold. An advantage of merging is that memory reduction can be achieved for storage of motion vectors, since the number of motion vectors is reduced.

An embodiment of the motion estimation unit according to the invention comprises an occlusion detector for controlling the testing means. An advantage of applying an occlusion detector is that object boundaries can be extracted from the occlusion map being calculated by the occlusion detector. The splitting of blocks is relevant nearby object boundaries and less within objects. Hence, applying an occlusion detector to control the testing means is advantageous, because computing resource usage is reduced. Optionally the occlusion map being determined for an image is used for a subsequent image of the series.

An embodiment of the motion estimation unit according to the invention is arranged to calculate normalized match errors. An advantage of applying normalized match errors is the robustness of the motion estimation. Besides that the match errors are a basis for the test whether the block of pixels has to be split. Normalization results in being less sensitive for the content of the images.

It is a further object of the invention to provide an image processing apparatus of the kind described in the opening paragraph which provides a motion vector field for variable sizes of groups of pixels of an image and which has a relatively low computing resource usage.

This object of the invention is achieved in that the image processing apparatus comprises:
receiving means for receiving a signal representing a series of images to be processed;
a motion estimation unit for estimating a motion vector for a group of pixels of an image of the series of images, comprising:
generating means for generating a set of motion vector candidates for the group of pixels;
matching means for calculating match errors for the respective motion vector candidates of the set;
selecting means for selecting a first one of the motion vector candidates as the motion vector for the group of pixels, on basis of the match errors; and
testing means for testing whether the group of pixels has to be split into sub-groups of pixels for which respective further motion vectors have to be estimated, similar to estimating the motion vector for the group of pixels, the testing being based on a measure related to a particular motion vector of the series of images; and
a motion compensated image processing unit for processing the series of images, which is controlled by the motion estimation unit.

The image processing apparatus may comprise additional components, e.g. a display device for displaying the processed images. The motion compensated image processing unit might support one or more of the following types of image processing:
Video compression, i.e. encoding or decoding, e.g. according to the MPEG standard.
De-interlacing: Interlacing is the common video broadcast procedure for transmitting the odd or even numbered image lines alternately. De-interlacing attempts to restore the full vertical resolution, i.e. make odd and even lines available simultaneously for each image;
Up-conversion: From a series of original input images a larger series of output images is calculated. Output images are temporally located between two original input images; and
Temporal noise reduction. This can also involve spatial processing, resulting in spatial-temporal noise reduction.

It is a further object of the invention to provide a method of the kind described in the opening paragraph which provides a motion vector field for variable sizes of groups of pixels of an image and which requires a relatively low computing resource usage.

This object of the invention is achieved in that the method of estimating a motion vector for a group of pixels of an image of a series of images, comprises:
generating a set of motion vector candidates for the group of pixels;
calculating match errors for the respective motion vector candidates of the set;
selecting a first one of the motion vector candidates as the motion vector for the group of pixels, on basis of the match errors; and
testing whether the group of pixels has to be split into sub-groups of pixels for which respective further motion vectors have to be estimated, similar to estimating the motion vector for the group of pixels, the testing being based on a measure related to a particular motion vector of the series of images.

Modifications of the motion estimation unit and variations thereof may correspond to modifications and variations thereof of the method and of the image processing apparatus described.

These and other aspects of the motion estimation unit, of the method and of the image processing apparatus according to the invention will become apparent from and will be elucidated with respect to the implementations and embodiments described hereinafter and with reference to the accompanying drawings, wherein:

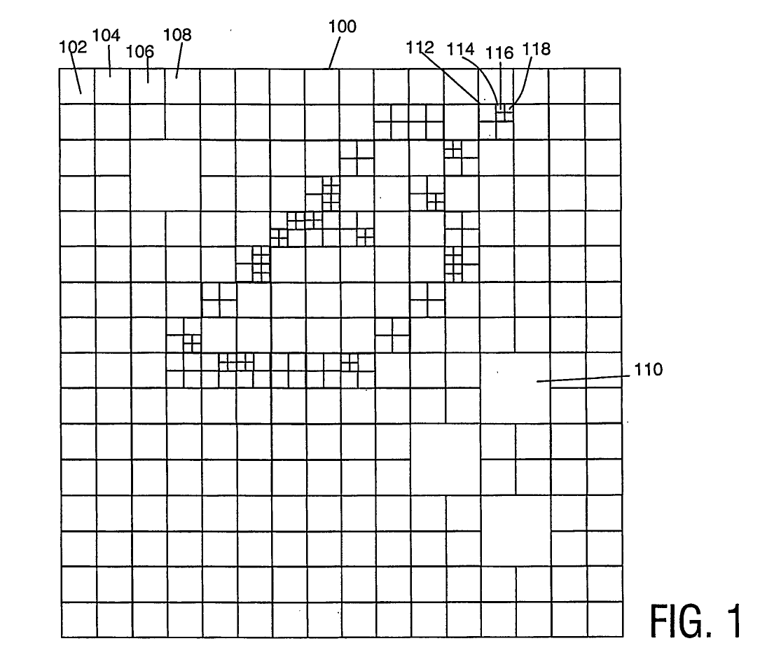

FIG. 1 schematically shows the blocks of pixels of a motion vector field being estimated according the method of the invention;

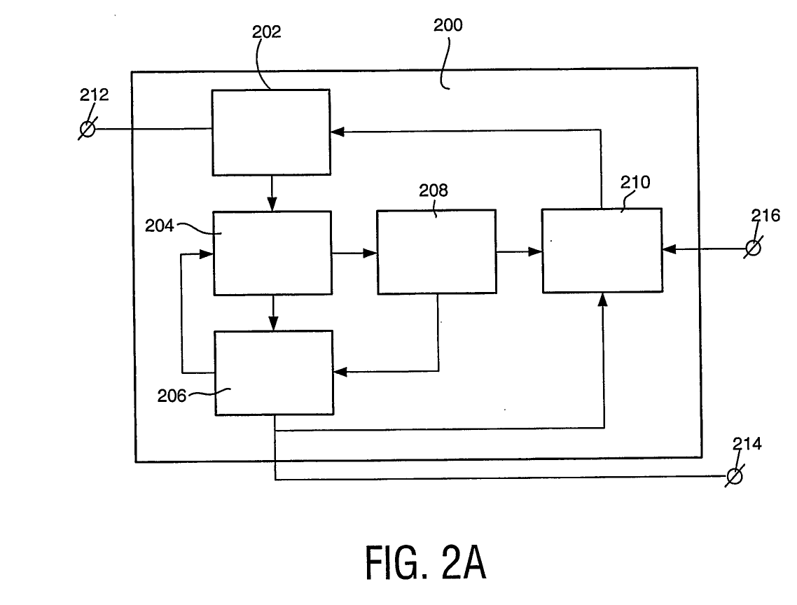

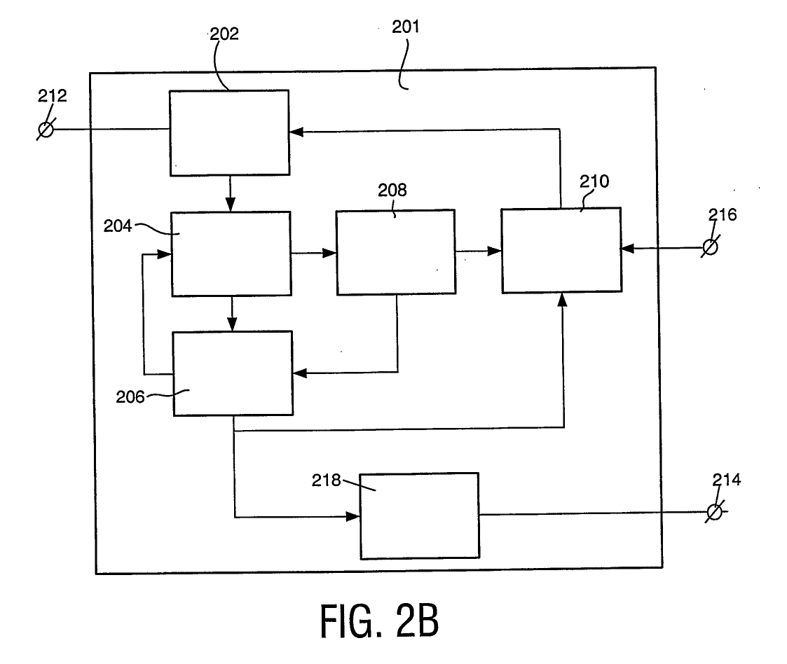

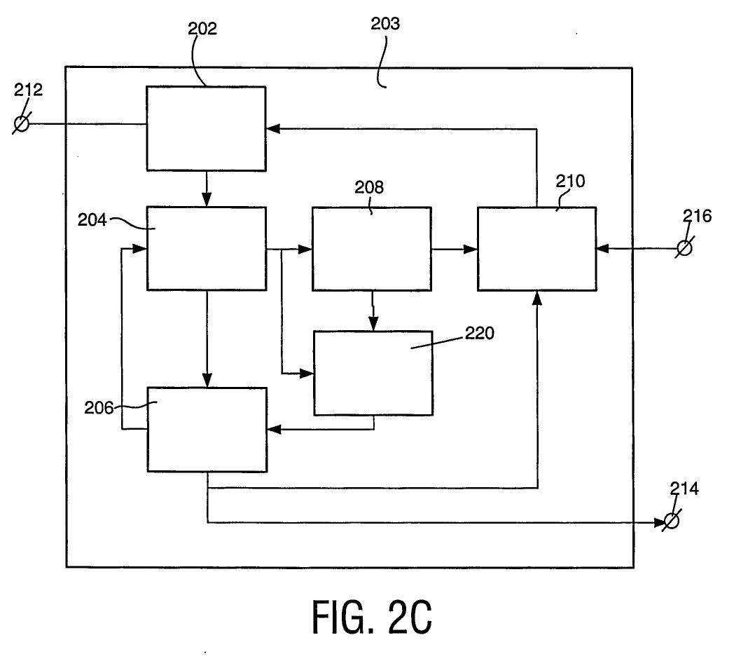

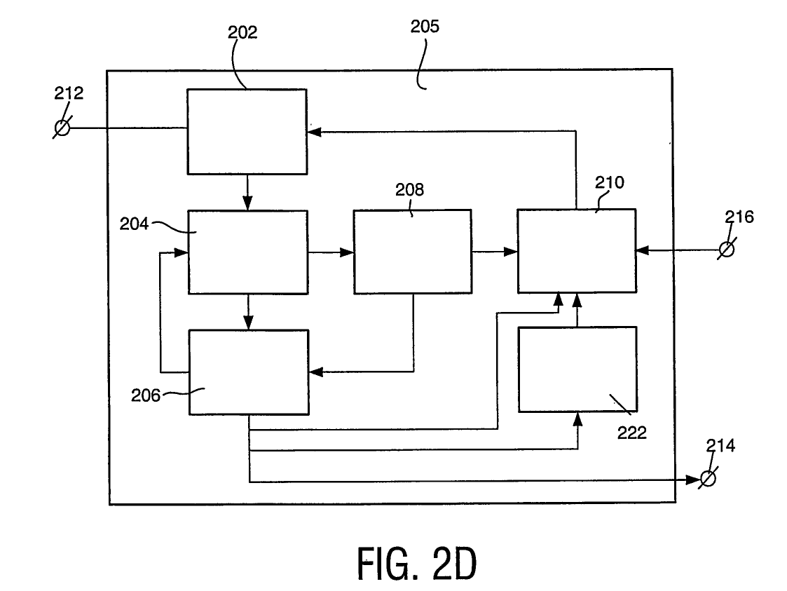

FIG. 2A schematically shows an embodiment of the motion estimation unit;

FIG. 2B schematically shows an embodiment of the motion estimation unit comprising a merging unit;

FIG. 2C schematically shows an embodiment of the motion estimation unit comprising a normalization unit;

FIG. 2D schematically shows an embodiment of the motion estimation unit comprising an occlusion detector; and

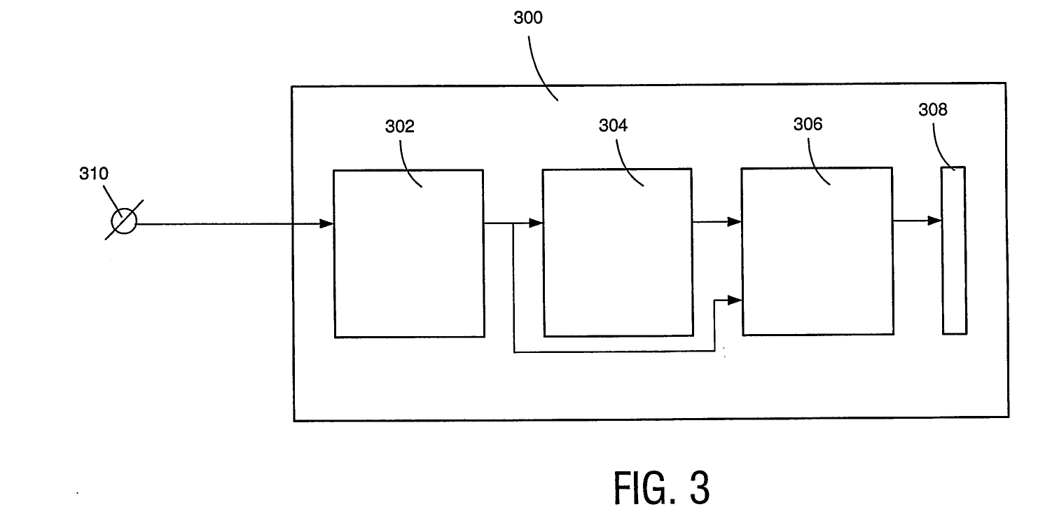

FIG. 3 schematically shows an embodiment of the image processing apparatus.

Corresponding reference numerals have the same meaning in all of the Figs.

FIG. 1 schematically shows the blocks of pixels 102-118 of a motion vector field 100 being calculated according the method of the invention. According that method the images is split into a number of relatively large blocks with a dimension corresponding to block 110. For these relatively large blocks motion vectors are estimated. Besides that it is tested whether these motion vectors are good enough to describe the apparent motion. If that is not the case for a particular block then that particular block is split into four sub-blocks, with dimensions corresponding to blocks 102-108 and 112. In FIG. 1 it can be seen that for most blocks with these latter dimensions, the estimated motion vectors were assumed to be appropriate. Note that splitting into a number of sub-blocks being not equal to four is also be possible. Sub-blocks can be split further, e.g. sub-block 112 is split into sub-blocks, e.g. 114 which is also split into sub-blocks, e.g. 116 and 118.

FIG. 2A schematically shows an embodiment of the motion estimation unit 200 comprising:
splitting means 202 for splitting a block of pixels into sub-blocks. Initially an image is split into a number of relatively large blocks with dimensions of e.g. 32×32 pixels;
generating means 204 for generating a set of motion vector candidates for a particular block of pixels. For this generating motion vectors being estimated for other blocks of pixels are used: so-called temporal and/or spatial motion vector candidates and random motion vector candidates are used. This principle is described in e.g. “True-Motion Estimation with 3-D Recursive Search Block Matching” by G. de Haan et. al. in IEEE Transactions on circuits and systems for video technology, vol.3, no.5, October 1993, pages 368-379;
matching means 208 for calculating match errors for the respective motion vector candidates of the set;
selecting means 206 for selecting a first one of the motion vector candidates as the motion vector for the particular block of pixels, by means of comparing the match errors. The candidate motion vector with the lowest match error is selected; and
testing means 210 for testing whether the particular block of pixels has to be split into sub-blocks of pixels for which respective further motion vectors have to be estimated, similar to the motion vector being estimated for the particular block of pixels. The testing is based on a measure related to the selected motion vector. The testing means 210 is designed to control the splitting means 202.

On the input connector 212 of the motion estimation unit 200 a series of images is provided. The motion estimation unit 200 provides a motion vectors at its output connector 214. Via the control interface 216 parameters which are related to the spitting, i.e. splitting criteria, can be provided. These parameters comprise the minimum dimensions of the blocks and thresholds for a measure which is related to the quality of the selected motion vector. Two examples of such a measure are described below. They will be referred to as “Variance of Quad-SAD”, var(\vec{ε}(\vec{c},\vec{x},\vec{n})) and “Vector Field Inconsistency”, VI. A combination of measures is preferred. That means e.g. that one possible criterion for splitting a block into four smaller blocks would be:
VI(\vec{x})>Tₛ\hat{ }var(ε(\vec{d},\vec{x},n))>Tᵥ (6)

In words the “Vector Field Inconsistency” is higher than a first predetermined threshold Tₛ and the “variance of Quad-SAD” is higher than a second predetermined threshold Tᵥ.

The “Vector Field Inconsistency” is related to the amount of difference between neighboring motion vectors. An example of the “Vector Field Inconsistency” is specified by means of Equation 7. In that case a particular motion vector is compared with four neighboring motion vectors. It will be clear that alternative approaches for calculating a “Vector Field Inconsistency” are possible: with more or with fewer neighboring motion vectors.

$$VI ( \vec{x} ) = {\sum }_{i = - 1}^{1} {\sum }_{j = - 1}^{1} ‖ {\vec{d}}_{avg} ( \vec{x} ) - \vec{d} ( \vec{x} + {( i {β}_{0}^{h} j {β}_{1}^{h} )}^{T} , n ) ‖ \\ with \vert i \vert + \vert j \vert \leq 1 \qquad ( 7 )$$

with βₒ^{h} and β₁^{h} the block dimensions at the highest level and with the local vector average defined by Equation 8:

$${\vec{d}}_{avg} ( \vec{x} ) = \frac{1}{5} {\sum }_{i = - 1}^{1} {\sum }_{j = - 1}^{1} \vec{d} ( \vec{x} + {( i {β}_{0}^{h} j {β}_{1}^{h} )}^{T} , n ) \\ with \vert i \vert + \vert j \vert \leq 1 \qquad ( 8 )$$

The “Variance of Quad-SAD” is specified by means of Equation 10. But first the Quad-SAD is specified in Equation 9. The so-called Quad-SAD, \vec{ε}(\vec{c},\vec{x},n) corresponds to a combination of four SAD values. Or in other words, a block at position \vec{x} is divided into four blocks and for each quadrant of the block a SAD is calculated, i.e.

$$\vec{ɛ} ( \vec{c} , \vec{x} , n ) = ( \begin{matrix}ɛ ( \vec{c} , {\vec{x}}_{11} , n ) & ɛ ( \vec{c} , {\vec{x}}_{12} , n ) \\ ɛ ( \vec{c} , {\vec{x}}_{21} , n ) & ɛ ( \vec{c} , {\vec{x}}_{22} , n )\end{matrix} ) \qquad ( 9 )$$

where the block at position \vec{x} is split into its quadrants with positions \vec{x}₁₁, . . . , \vec{x}₂₂i.e. four equally sized smaller blocks. The Quad-SAD can be derived from the SAD values without any additional computational cost. Then the “Variance of Quad-SAD” can be calculated by e.g.:
var(\vec{ε}(\vec{c},\vec{x},n))=|ε(\vec{c},\vec{x}₂₁,n)−ε(\vec{c},\vec{x}₂₂,n)|+|ε(\vec{c},\vec{x}₁₁,n)−ε(\vec{c},\vec{c},\vec{x}₂₁,n)|+|ε(\vec{c},\vec{x}₁₂,n)−ε(\vec{c},\vec{x}₂₂,n)| (10)

The basic idea behind the criterion as specified in Equation (6) is that the lowest level, i.e. small block sizes is required only near the edges in the vector field. Areas containing an edge in the vector field are characterized by a VI value above the threshold Tₛ. The presence of the edge is characterized by high SAD values for one part of the block and low values for other parts. Resulting in a large variation of the SAD values within the Quad-SAD.

FIG. 2B schematically shows an embodiment of the motion estimation unit 201 comprising a merging unit 218. This embodiment of the motion estimation unit is designed to compare neighboring motion vectors. If these motion vectors are equal or the difference between the neighboring motion vectors is below a predetermined threshold then the corresponding blocks of pixels are merged into a merged block of pixels. The merging can be performed after the motion vector field has been estimated, but alternatively the merging is performed simultaneously with the creation of the motion vector field.

FIG. 2C schematically shows an embodiment of the motion estimation unit 203 comprising a normalization unit 220. An approach for normalization of match errors is described in the European patent application with application number 01202641.5 (attorneys docket number PHNL010478). In that patent application is described that a variance VAR parameter is being calculated by summation of absolute differences between pixel values of the block of pixels of the image and pixel values of other blocks of pixels of the image. By comparing the VAR with the SAD an expected vector error VE is determined. This VE is a measure for the quality of the motion vector: a measure for the difference between the estimated motion vector and the actual motion vector. In the above patent application a model is derived for the expected vector error VE given the SAD and the VAR value, i.e.

$$E ( VE ) \approx \frac{3 SAD}{5 VAR} \qquad ( 11 )$$

However, this model is only valid if there is only one motion vector appropriate for the block, i.e. when splitting of the block is not required. Hence, Equation 11 can be applied to predict the expected SAD value. When the motion estimation has converged it is expected that the vector error VE is low, e.g. ½ pixel. If the SAD value is higher than the expected SAD value the block is split up. Hence the split criterion becomes:

$$VI ( \vec{x} ) > {T}_{s} ⋀ {min ɛ ( \vec{c} , \vec{x} , n )}_{{c}^{->}} > \frac{5 VAR ( \vec{x} ) VE}{3} \qquad ( 12 )$$

where VAR(\vec{x}) is e.g. given by:

$$VAR ( \vec{x} ) = \frac{1}{2} {\sum }_{{{x}^{->}}^{′} ∈ B ( \vec{x} )} \vert f ( {\vec{x}}^{′} , n ) - f ( {\vec{x}}^{′} + 2 {\vec{e}}_{x} , n ) \vert + \\ \vert f ( {\vec{x}}^{′} , n ) - f ( 2 {\vec{e}}_{y} , n ) \vert \qquad ( 13 )$$

with \vec{e}ₓ and \vec{e}_{y} unity vectors in x-direction and y-direction, respectively. Thus, the threshold in Equation 12 on the SAD value becomes the allowed vector error.

FIG. 2D schematically shows an embodiment of the motion estimation unit 205 comprising an occlusion detector 222, which provides an occlusion map to the testing means 210. In an occlusion map is defined which regions of the image correspond to covering area or uncovering area. An approach for calculating an occlusion map on basis of a motion vector field is described in the patent application which is entitled “Problem area location in an image signal” and published under number WO0011863. In that patent application is described that an occlusion map is determined by means of comparing neighboring motion vectors of a motion vector field. It is assumed that if neighboring motion vectors are substantially equal, i.e. if the absolute difference between neighboring motion vectors is below a predetermined threshold, then the groups of pixels to which the motion vectors correspond, are located in a no-covering area However if one of the motion vectors is substantially larger than a neighboring motion vector, it is assumed that the groups of pixels are located in either a covering area or an uncovering area. The direction of the neighboring motion vectors determines which of the two types of area. An advantage of this method of occlusion detection is its robustness. An advantage of applying an occlusion detector is that object boundaries can be extracted from the occlusion map. Splitting a block into sub-blocks is relevant at covering areas, the exact border of the object has to be found. In the case of a block situated at an uncovering area, it is not very useful to split the block into sub-blocks because of the uncertainty.

The motion estimation units 200, 201, 203, 205 as described in connection with the FIGS. 2A-2D, respectively are designed to perform the motion estimation in one of the following two modes:
Multi-pass, which works as follows: First the images is split into blocks and for each block the motion vectors are determined. In a subsequent pass the various blocks are processed again. That means that they are optionally split into sub-blocks and for the sub-blocks the motion vectors are estimated. After that another similar pass might be performed.
Single pass, which works as follows: A block is recursively split till the appropriate level in the block-hierarchy, i.e. block-size, is reached for that block. Then a neighboring block is processed in a similar way. This single pass strategy is preferred, because it is assumed that the best motion vectors are found on the lowest level in the block-hierarchy and these motion vectors are provided as candidate motion vectors for a subsequent block. In other words, potentially better candidate motion vectors are provided in the single-pass mode.

FIG. 3 schematically shows elements of an image processing apparatus 300 comprising:
receiving means 302 for receiving a signal representing images to be displayed after some processing has been performed. The signal may be a broadcast signal received via an antenna or cable but may also be a signal from a storage device like a VCR (Video Cassette Recorder) or Digital Versatile Disk (DVD). The signal is provided at the input connector 310.
a motion estimation unit 304 as described in connection with any of the FIGS. 2A-2D;
a motion compensated image processing unit 306; and
a display device 308 for displaying the processed images. This display device 308 is optional.

The motion compensated image processing unit 306 requires images and motion vectors as its input.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A motion estimation unit for estimating a motion vector for a group of pixels of an image of a series of images, comprising:
generating means for generating a set of motion vector candidates for the group of pixels;
matching means for calculating match errors for the respective motion vector candidates of the set;
selecting means for selecting a first one of the motion vector candidates as the motion vector for the group of pixels, on basis of the match errors; and
testing means for testing whether the group of pixels has to be split into sub-groups of pixels for which respective further motion vectors have to be estimated, similar to estimating the motion vector for the group of pixels, the testing being based on a measure related to a particular motion vector of the series of images.

2. A motion estimation unit as claimed in claim 1, characterized in that the particular motion vector is the first one of the motion vector candidates.

3. A motion estimation unit as claimed in claim 1, characterized in that the group of pixels corresponds to a block of pixels and that the sub-groups of pixels corresponds to respective sub-blocks of pixels.

4. A motion estimation unit as claimed in claim 3, characterized in that the testing means are designed to test whether a first one of the sub-blocks of pixels has to be split into further sub-blocks of pixels for which respective other motion vectors have to be estimated, similar to the motion vector being estimated for the block of pixels.

5. A motion estimation unit as claimed in claim 3, characterized in that the matching means are arranged to calculate the match error of the motion vector which corresponds to a sum of absolute differences between values of pixels of the block of pixels and respective further values of pixels of a further block of pixels of another image of the series of images.

6. A motion estimation unit as claimed in claim 3, characterized in that the measure related to the particular motion vector is based on a difference between the motion vector and a neighbor motion vector being estimated for a neighbor block of pixels in the neighborhood of the block of pixels.

7. A motion estimation unit as claimed in claim 3, characterized in that the measure related to the particular motion vector is based on a difference between a first intermediate result of calculating the match error and a second intermediate result of calculating the match error, the first intermediate result corresponding to a first portion of the block of pixels and the second intermediate result corresponding to a second portion of the block of pixels.

8. A motion estimation unit as claimed in claim 3, characterized in that the testing means are designed to test whether the block of pixels has to be split into the sub-groups of pixels, on basis of a dimension of the block of pixels.

9. A motion estimation unit as claimed in claim 3, characterized in comprising a merging unit (218) for merging a set of sub-blocks of pixels into a merged block of pixels and for assigning a new motion vector to the merged block of pixels, by selecting a first one of the further motion vectors corresponding to the sub-blocks of the set of sub-blocks.

10. A motion estimation unit as claimed in claim 3, characterized in comprising an occlusion detector for controlling the testing means.

11. A motion estimation unit as claimed in claim 3, characterized in the being arranged to calculate normalized match errors.

12. An image processing apparatus comprising:
receiving means for receiving a signal representing a series of images to be processed;
a motion estimation unit for estimating a motion vector for a group of pixels of an image of the series of images, comprising:
generating means for generating a set of motion vector candidates for the group of pixels;
matching means for calculating match errors for the respective motion vector candidates of the set;
selecting means for selecting a first one of the motion vector candidates as the motion vector for the group of pixels, on basis of the match errors; and
testing means for testing whether the group of pixels has to be split into sub-groups of pixels for which respective further motion vectors have to be estimated, similar to estimating the motion vector for the group of pixels, the testing being based on a measure related to a particular motion vector of the series of images; and
a motion compensated image processing unit for processing the series of images, which is controlled by the motion estimation unit.

13. An image processing apparatus as claimed in claim 12, characterized in that the motion compensated image processing unit is designed to perform video compression.

14. An image processing apparatus as claimed in claim 12, characterized in that the motion compensated image processing unit is designed to reduce noise in the series of images.

15. An image processing apparatus as claimed in claim 12, characterized in that the motion compensated image processing unit is designed to de-interlace the series of images.

16. An image processing apparatus as claimed in claim 12, characterized in that the motion compensated image processing unit is designed to perform an up-conversion.

17. A method of estimating a motion vector for a group of pixels of an image of a series of images, comprising:
generating a set of motion vector candidates for the group of pixels;
calculating match errors for the respective motion vector candidates of the set;
selecting a first one of the motion vector candidates as the motion vector for the group of pixels, on basis of the match errors; and
testing whether the group of pixels has to be split into sub-groups of pixels for which respective further motion vectors have to be estimated, similar to estimating the motion vector for the group of pixels, the testing being based on a measure related to a particular motion vector of the series of images.
